(19) United States
(12) Patent Application Publication
(10) Pub. No.: US 2023/0289312 A1
(43) Pub. Date: Sep. 14, 2023

(54) Automatic USB3 Hub for Detecting and Changing Link Speed

(71) Applicant: Microchip Technology Incorporated, Chandler, AZ (US)

(72) Inventor: Andrew Rogers, Tempe, AZ (US)

(73) Assignee: Microchip Technology Incorporated, Chandler, AZ (US)

(21) Appl. No.: 18/077,385

(22) Filed: Dec. 8, 2022

Related U.S. Application Data
(60) Provisional application No. 63/319,002, filed on Mar. 11, 2022.

(51) Int. Cl. G06F 13/40; G06F 13/16

(52) U.S. Cl. CPC G06F 13/4068; G06F 13/1694; G06F 2213/0042

(57) ABSTRACT

A USB control method comprising: counting errors encountered by a USB connection; comparing a number of counted errors to an error count threshold within a set time frame; identifying a port speed configuration for the USB connection; and changing the port speed configuration for the USB connection to a slower port speed configuration than the identified port speed configuration.

### RELATED PATENT APPLICATION

This application claims priority to commonly owned U.S. Patent Application No. 63/319,002 filed Mar. 11, 2022, the entire contents of which are hereby incorporated by reference for all purposes.

### FIELD OF THE INVENTION

The present application relates to USB3 link operations, and in particular, relates to systems and methods to detect marginal USB3 link operation and change link connection speed to improve overall performance.

### BACKGROUND

The Universal Serial Bus (USB) 1.0 specification was originally developed in the 1990s to provide a bus and interface(s) to standardize communication between computers and peripheral devices, such as keyboards, printers, cursor pointing devices, external drives, and the like. USB 1.0 supports speeds up to 1.5 Mbps and USB 1.1 supports speeds up to 12 Mbps. Since then, USB has progressed into versions 2.0 and 3.0 and became ubiquitous in computers as well as portable devices, such as smartphones, tablet computers, and MP3 players. USB 2.0 supports speeds up to 480 Mbps. Later, USB 3.0 became a universal standard and supports speeds up to 5 Gbps. USB 3.0 and/or USB 3.1 came to have Gen 1 and Gen 2 capabilities. The difference between USB 3.1 Gen 1 and USB 3.1 Gen 2 is only in terms of speed. USB 3.1 Gen 1 supports speeds of up to 5 Gbps, while USB 3.1 Gen 2 supports speeds of up to 10 Gbps. Still later, USB 3.2 became a universal standard. Similarly, the difference between USB 3.2 Gen 1 and USB 3.2 Gen 2 is only in terms of speed. USB 3.2 Gen 1 supports speeds of up to 5 Gbps, while USB 3.2 Gen 2 supports speeds of up to 10 Gbps.

In general, in USB communication, a host is defined, and another peripheral acts as a device, connected to the host over a bus. The host powers the bus, issues commands, and generally maintains control over the connection. The peripheral device usually does not initiate any activity for control of the bus. For example, a personal computer acts as a host to a USB “thumb drive” device. A USB hub is a device that expands a single USB port into several USB ports, so that there are more ports available to connect devices to the host.

The USB Type-C connector has been developed to help enable thinner and sleeker product designs, enhance usability and provide a growth path for performance enhancements for future versions of USB. The Type-C connector is built on existing USB 3.1 and USB 2.0 technologies. USB Type-C is a 24-pin USB connector system with a rotationally symmetrical connection. The designation C refers only to the connector's physical configuration or form factor and should not be confused with the connector's specific capabilities, which are designated by its transfer specifications.

When USB devices are connected to a host via USB cable connections, poor quality communications are sometimes encountered. The current USB specifications do not provide a solution for poor quality connections and assumes USB devices and hosts will act to mitigate data loss issues. Current USB devices, hosts, and hubs do little to address poor data transmission. In particular, the current USB specification does not envision the USB hub taking an active role in error detection and mitigation. No mechanisms exist today, and this type of functionality has not been observed in currently available USB hubs.

There is a need for a USB hub, host, or device that can automatically detect significant or critical data loss in a USB connection and take corrective action so the impact to the end user can be reduced.

### SUMMARY

An apparatus includes a non-transitory, machine-readable medium including instructions. The instructions, when loaded and executed by a processor, cause the processor to perform automatic USB hub poor link quality detection and speed roll-back. A USB host may force individual USB hub ports to specified USB speeds (i.e., force a USB port operating at Gen2 speeds to switch to Gen1 speed due to excessive errors detected when operating at Gen2 speeds).

According to one aspect, there is provided a method comprising: counting errors encountered by a USB connection; comparing a number of counted errors to an error count threshold within a set time frame; identifying a port speed configuration for the USB connection; and changing the port speed configuration for the USB connection to a slower port speed configuration than the identified port speed configuration

A further aspect provides an apparatus having a connection detector circuit that counts errors encountered by a USB connection operating at an initial speed, compares a number of counted errors to a preset threshold number of errors, and identifies a port speed configuration for the USB connection, and a control circuit that changes the port speed configuration of the USB connection to a speed slower than the initial speed.

According to another aspect, there is provided a system having a USB hub with an upstream port, a downstream port, and a switch in electrical communication with the upstream port and the downstream port, a USB host in electrical communication with the upstream port via a first USB connection, a USB device in electrical communication with the downstream port via a second USB connection, a connection detector circuit that counts errors encountered by either the first or second USB connection, compares a number of counted errors to a preset threshold number of errors, and identifies a port speed configuration for either the first or second USB connection, and a control circuit that changes the port speed configuration of either the first or second USB connection to a slower speed.

### BRIEF DESCRIPTION OF THE DRAWINGS

The figures illustrate example flows and systems for detecting marginal USB3 link operation and throttle connection speed to improve overall performance and prevent disconnect. Various error counters for each port may be implemented and specific actions may be taken to throttle connection speed when a counter exceeds a configured threshold.

FIG. 1 is a diagram illustrating an example USB environment that includes a USB hub, a USB host, and a USB device, wherein the USB hub has a connection detector circuit and a speed circuit.

FIG. 2 shows a flow chart algorithm for the connection detector and speed circuits of FIG. 1 whereby the USB hub may detect a poor quality USB connection and throttle the connection to improve performance.

FIG. 3 is a diagram illustrating an example USB environment that includes a hub, a USB host, and a USB device, wherein the USB host has a connection detector circuit and the USB hub has a speed circuit.

FIG. 4 shows a flow chart algorithm for the connection detector and speed circuits of FIG. 3 whereby the USB host may detect a poor quality USB connection and throttle the connection to improve performance.

FIG. 5 is a diagram illustrating an example USB environment that includes a hub, a USB host, and a USB device, wherein the USB device has a connection detector circuit and the USB hub has a speed circuit.

FIG. 6 shows a flow chart algorithm for the connection detector and speed circuits of FIG. 5 whereby the USB device may detect a poor quality USB connection and the speed circuit may throttle the connection to improve performance.

FIG. 7 shows a schematic diagram for a software implementation of a connection detection circuit.

FIG. 8 shows a schematic diagram for detecting a poor quality USB connection and throttling the connection to improve performance, comprising a connection detection circuit and a speed circuit.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

Automatic USB hosts, automatic USB hubs, and automatic USB devices are described herein for poor link quality detection and speed roll-back. Automatic connections are made either when the user plugs a USB device in to a USB host or a USB hub and the ports and speeds are configured according to policy settings. Further, automatic USB hosts, automatic USB hubs, and automatic USB devices may be used in USB3 interfaces with Type-C functionality by implementing various error counters for each port, and taking specific actions to throttle connection speed when a counter exceeds a configured threshold. For example, USB hubs may allow poor quality devices or devices connected with poor quality cables to operate at a reduced signal rate in order to prevent total failure. USB hubs may fine tune the functionality to meet custom specifications. USB hubs may be compatible for USB devices and cables to operate together. Of course, the USB hub functionality may be implemented with firmware of the USB hub and may not have a new hardware design, but hardware implementations are possible and reduce the burden on firmware and improve reliability.

One aspect may allow poor quality devices or devices connected with poor quality cables to operate at a reduced signal rate in order to prevent total failure. Poor quality refers to a transmission rate having more than a threshold amount of errors over a given time period. USB hubs may fine tune the functionality to meet the specifications/needs of the host/hub/device environment. Devices plus cables which would simply not work at the set signal rate may be configured to operate at a slower signal rate with connection detector circuits as disclosed herein. Examples may be implemented within firmware of the host, hub or device, and may not have new hardware design. Alternatively, a hardware implementation may also reduce the burden on firmware development and improve reliability if implemented with hardware.

When USB devices are connected via USB cable connections, poor quality communications are sometimes encountered. For example, a USB3.2 device, i.e. a device that meets the USB 3.2 standard released by the USB Implementers Forum (USB-IF), may be connected to a USB hub port with a poor quality USB cable. More particularly, a USB3 Gen2 device, supporting 10 Gbit/second with a poor quality cable may have lower overall data throughput than the same device and cable when connected to a USB3 Gen1 port, which USB3 Gen1 port supports 5 Gbit/second. Poor data communication can also happen on a USB hub upstream port as well, e.g., between the USB hub and the USB host, causing connections to all devices on the downstream ports to suffer. In such cases, there may be three possible data loss scenarios: (1) minimal to moderate data loss with occasional corrupted packets; (2) significant data loss with frequent corrupted packets and USB3 link recovery initiation; or (3) critical data loss wherein three packets fail back-to-back. An average user would not likely notice the first scenario of minimal to moderate data loss. However, an average user would likely notice the second scenario because the overall data throughput would be much lower. In the third scenario, an average user would certainly notice connection issues because a USB host would likely take action by shutting off the USB device.

Detection of a poor quality USB connection may be implemented via various firmware or hardware-based error counters. Types of errors counted may include: number of entries to link recovery; number of warm resets received; number of retries detected; and number of LBAD (link bad) link commands received. For example, for any of these types of errors, if fifteen errors are counted in one second, the USB connection may be determined to be poor quality. End system integrator configurable parameters may include: mask operation on error type; error counter thresholds (1 per error type), wherein a user may set a threshold to define what “excessive” means; mode select an infinite error count persistence mode or a rolling window mode; and rolling window timing. A threshold for detecting an error condition indicative of a poor quality USB connection may be based on a single error type, or it may be based on a combination of error types, and it may also be based on the number of errors counted per unit time. For a combination example, a threshold may be preset for a first error type and another threshold may be set for a second error type, and both thresholds would be met before the quality of the USB connection would be determined to be poor. New hardware or USB devices may be run in the port to implement error counters. The connection quality may be detected/throttled by the USB hub, the USB host, or the USB device.

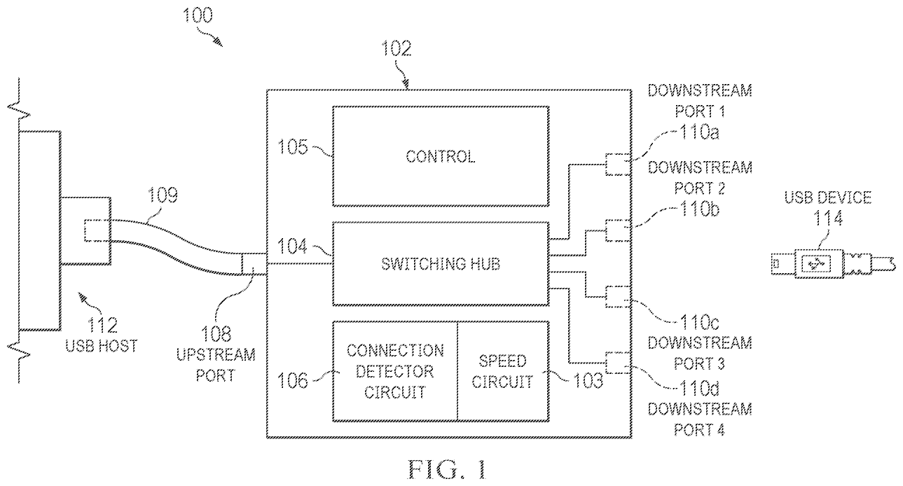

Turning to the drawings and, with particular attention to FIG. 1, a diagram illustrating an example USB hub environment in accordance with an example is shown. As shown, the system 100 includes a USB hub 102, a USB host 112, and a USB device 114. The USB hub 102 has an upstream port 108 and four downstream ports 110a, 110b, 110c, 110d. A switching hub 104 switches between the downstream ports 110a, 110b, 110c, 110d. A control circuit 105 functions to receive and process signals over the USB port(s) and controls the switching hub 104. The control circuit 105 may be implemented by instructions in a medium for execution by a processor, a function, library call, subroutine, shared library, software as a service, analog circuitry, digital circuitry, control logic, digital logic circuits programmed through hardware description language, application-specific integrated circuit (ASIC), field-programmable gate array (FPGA), programmable logic device (PLD), or any suitable combination thereof, or any other suitable mechanism, whether in a unitary device or spread over several devices. A connection detector circuit 106 detects errors per unit of time and identifies port speeds. A speed circuit 103 changes the port to a slower speed configuration. Both the connection detector circuit 106 and the speed circuit 103 may be implemented by instructions in a medium for execution by a processor, a function, library call, subroutine, shared library, software as a service, analog circuitry, digital circuitry, control logic, digital logic circuits programmed through hardware description language, application-specific integrated circuit (ASIC), field-programmable gate array (FPGA), programmable logic device (PLD), or any suitable combination thereof, or any other suitable mechanism, whether in a unitary device or spread over several devices.

The USB hub 102 may be implemented as a USB46x4 hub available from Microchip Technology Incorporated, of Chandler, Ariz., if modified to include a connection detector circuit 106 and speed circuit 103, as described herein. In this illustration, the USB host 112 is connected to the USB hub 102 via a cable 109. The USB device 114 may also be connected to the hub 102 via one of the downstream ports 110a, 110b, 110c, 110d, wherein a Type-C connector may be used for the connection. In FIG. 1, the USB hub 102 has a connection detector circuit 106 that includes hardware based error counters, firmware, or both, to throttle connections. The connection detector circuit 106 may be implemented by instructions in a medium for execution by a processor, a function, library call, subroutine, shared library, software as a service, analog circuitry, digital circuitry, control logic, digital logic circuits programmed through hardware description language, application-specific integrated circuit (ASIC), field-programmable gate array (FPGA), programmable logic device (PLD), or any suitable combination thereof, or any other suitable mechanism, whether in a unitary device or spread over several devices.

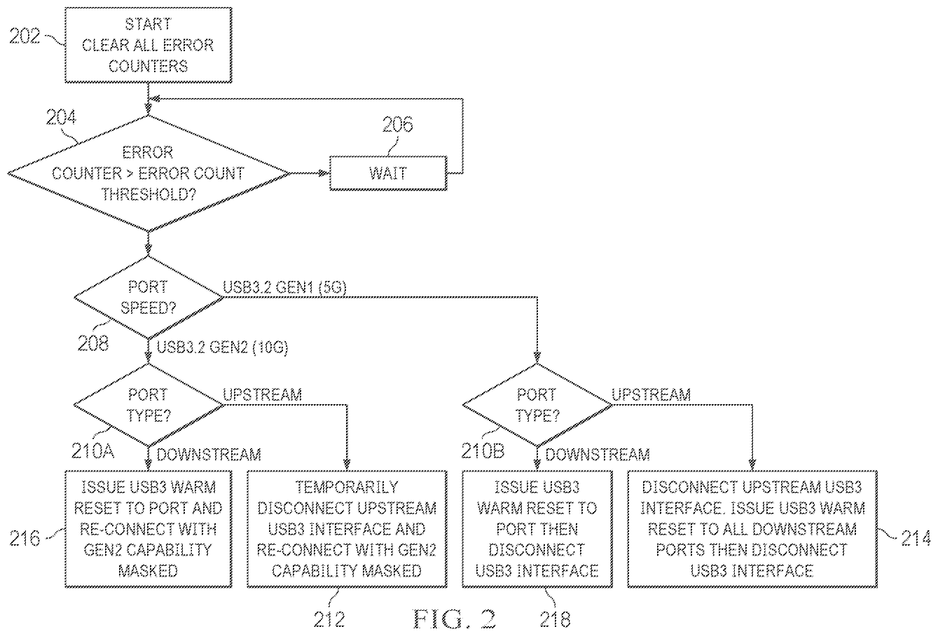

FIG. 2 shows a flow chart algorithm for the connection detector circuit 106 of FIG. 1 whereby the USB hub 102 detects a poor quality USB connection and throttles the connection to improve performance. In this case, the USB hub 102 monitors the USB connection through upstream port 108 and cable 109 as well as the downstream ports 110a-110d, and checks whether these connections are to a USB host or to USB devices. The algorithm starts by clearing 202 all error counters. Errors are then counted 204 and a determination is made whether the error count has exceeded an error count threshold within a set time frame. If the error counter threshold is not exceeded within the set time frame, the algorithm waits 206, clears 202 the error counters, and again begins another count 204 of error within a new set time frame. If the error counter threshold is exceeded within the set time frame, the algorithm next determines the port speed 208 for the connection for which the error counter threshold is exceeded within the set time frame: e.g., USB3.2 Gen2 (10G) or USB3.2 Gen1 (5G). In both cases, the algorithm next determines 210A and 210B the port type: (1) upstream (e.g., connection to USB host 112); or (2) downstream (e.g. connection to USB device 114). If the error counter threshold is exceeded within the set time frame 204, which may be indicative of a poor connection, on an upstream port configured for USB3.2 Gen2 (10G) speeds, the connection detector circuit 106, or control circuit 105, or both, temporarily disconnects 212 the upstream port USB3 interface and reconnects with Gen2 capability masked, thereby enforcing a lower data speed, i.e. the throughput of USB3 Gen1. This action causes the upstream connection to drop to a USB3 Gen 1 (5G) port speed connection, by a respective action of the USB host 112. If the port for which the error counter threshold is exceeded within the set time frame is detected on an upstream port (e.g., connection to USB host 112) configured for USB3 Gen 1 (5g) speed, the connection detector circuit 106 disconnects 214 the upstream port USB3 interface and issues a USB3 warm reset to all of the downstream ports with USB3 devices attached and then disconnects/deactivates all of the downstream USB3 interface(s). This action causes the downstream connection to reconfigure for USB2. If the port for which the error counter threshold is exceeded within the set time frame is a downstream port configured for USB3.2 Gen2 (10G) speeds, the connection detector circuit 106, or control circuit 105, or both, issues a ware reset 216 to the downstream port, and masks Gen2 capability bits, and then reconnects the port with Gen2 capability bits masked. This action causes the connection to reconfigure for USB3 Gen1 (5G) speeds. If the port for which the error counter threshold is exceeded within the set time frame is on a downstream port configured for USB3.2 Gen1 (5G) speeds, the connection detector circuit 106, or control circuit 105, or both, issues a warm reset to the port, and disconnects/deactivates the USB3 interface. This action causes the connection to reconfigure for USB2 speeds.

For connection quality detection by a USB hub, when an error count rises above a specific threshold within the set time frame, one or more of the routines provided in Table 1 may be initiated.

TABLE 1

| ERROR | | |
|---|---|---|
| CONDITION | REACTION | END RESULT |
| Excessive errors | Temporarily Disconnect Upstream | Upstream/Device |
| on Upstream Port | Port USB3 interface and | Connection will |
| at USB3.2 Gen2 | reconnect at with Gen2 | reconnect at |
| speeds. | capability masked. | USB3 Gen 1 |
| Excessive errors | Disconnect Upstream Port USB3 | Devices will |
| on Upstream Port | interface + | reconnect at |
| at USB3.2 Gen1 | Issue USB3 Warm Rest to all | USB2 |
| speeds. | downstream ports with USB3 | |
| | devices attached and | |
| | disconnect/deactivate | |
| | downstream USB3 interface(s). | |
| Excessive errors | Issue USB3 Warm Reset and | Devices will |
| on Downstream | reconnect with Gen2 capability | reconnect at |
| Port at USB3.2 | masked. | USB3 Gen 1 |
| Gen2 speeds. | | |
| Excessive errors | Issue USB3 Warm Reset to Port | Devices will |
| on Downstream | and disconnect/deactivate | reconnect at |
| Port at USB3.2 | downstream USB3 interface. | USB2 |
| Gen1 speeds. | | |

This functionality may be implemented in the USB hub's firmware or hardware.

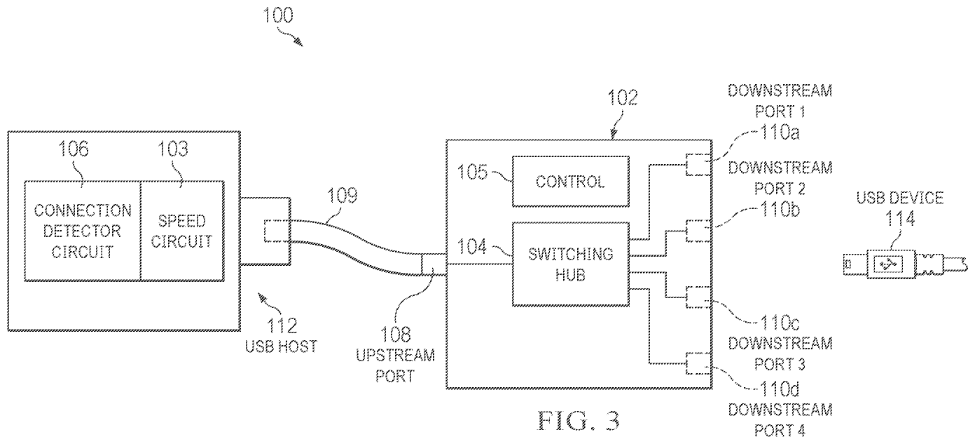

FIG. 3 illustrates a diagram of an example USB hub environment similar to the environment shown in FIG. 1 except that the connection detector circuit 106 and speed circuit 103 are in the USB host 112. The USB Host 112 has a connection detector circuit 106 that may include hardware based error counters, or firmware, or both, to determine the quality of the throughput and the speed circuit 103 may include hardware, or firmware, or both to the throttle connections. The USB host 112 is connected to the hub 102 via a cable 109 through upstream port 108. In an example, the connection detector circuit 106 may be in the USB Host 112 and the speed circuit 103 may be in the USB Hub 102. In an example, the connection detector circuit 106 may be in the USB Hub 102 and the speed circuit 103 may be in the USB Host 112.

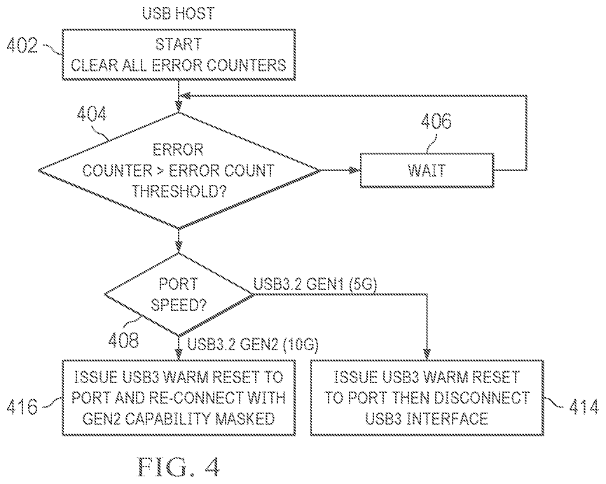

FIG. 4 shows a flow chart algorithm for the connection detector circuit 106 of FIG. 3 whereby the USB host 112 detects a poor quality USB connection (cable 109 and upstream port 108) and throttles the connection to improve performance. The connection detector circuit 106 starts by clearing 402 all error counters. Errors are then counted 404 and a determination is made whether the error count has exceeded an error count threshold within a set time frame. If the error counter threshold is not exceeded within the set time frame, the algorithm waits 406, clears the error counters 402, and begins another count 404 of error within the set time frame, i.e. within a next set time frame. If the error counter threshold is exceeded within the set time frame, the algorithm next determines 408 the port speed for the connection: USB3.2 Gen2 (10G) or USB3.2 Gen1 (5G). If the error counter threshold is exceeded within the set time frame for a USB connection 109, the algorithm of the speed circuit 103 configures for USB3 Gen2 (10G) speeds, wherein the speed circuit 103 issues a USB3 warm reset to the port and reconnects with Gen2 capability bits masked. This action causes the connection to reconfigure for USB3 Gen1 (5G) speeds. If the error counter threshold is exceeded within the set time frame for a USB connection 109 configured for USB3.2 Gen1 (5G) speeds, the speed circuit 103 issues a USB3 warm reset 414 to the port and disconnects/deactivates the USB3 interface. This action causes the connection to reconfigure for USB2 speed, since USB3 capability has been disconnected/deactivated.

For connection quality detection by a USB Host, when an error count rises above a specific threshold within a set time frame, one or more of the routines provided in Table 2 may be initiated.

TABLE 2

| ERROR | | |
|---|---|---|
| CONDITION | REACTION | END RESULT |
| Excessive errors | Issue a USB3 WARM RESET | Connection will |
| on Downstream | and mask Gen2 capability bits | reconnect at |
| Port at USB3.2 | on USB3 interface. | USB3 Gen 1 |
| Gen2 speeds. | | |
| Excessive errors | Issue a USB3 WARM RESET | Connection will |
| on Downstream | and disconnect/deactivate | reconnect at |
| Port at USB3.2 | USB3 interface. | USB2 |
| Gen1 speeds. | | |

This functionality may be implemented in the USB host's firmware or hardware.

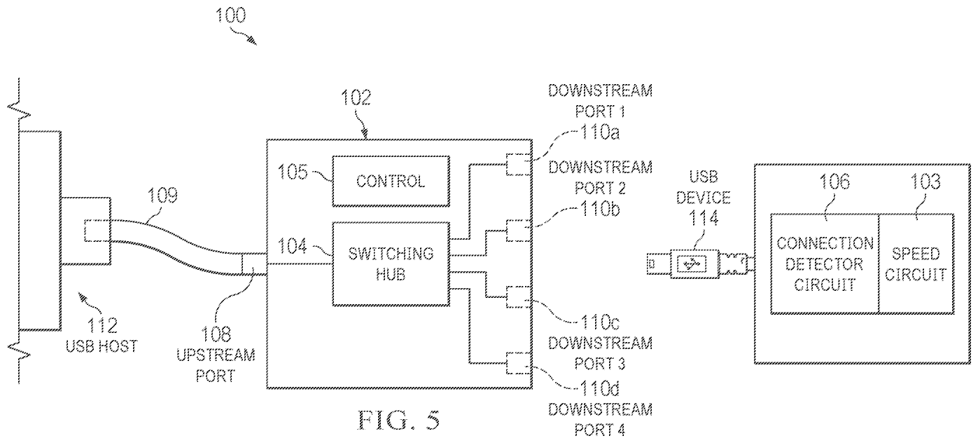

FIG. 5 shows a diagram where the connection detector circuit 106 is in the USB device 114 in the example USB hub environment. As shown, the system 100 includes a hub 102, one or more control circuits 105, a USB host 112, and a USB device 114, wherein a number of USB devices 114 may be connected to the hub 102 via downstream ports 110a-110d. The USB device 114 has a connection detector circuit 106 that includes hardware based error counters, or firmware based error counters, or both, and a speed circuit 103 to throttle connections.

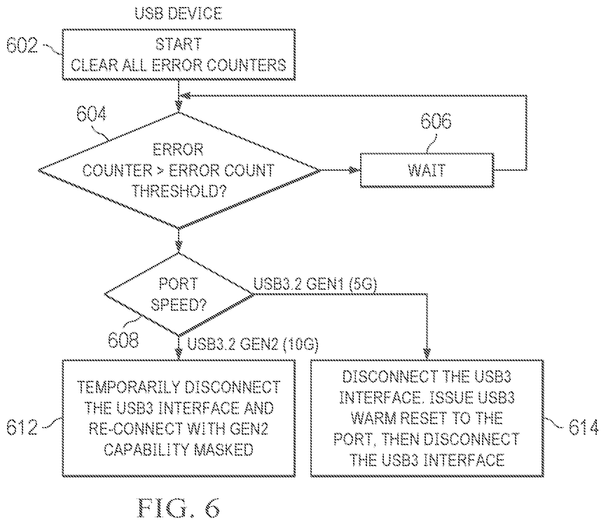

FIG. 6 shows a flow chart algorithm for the connection detector circuit 106 and speed circuit 103 of FIG. 5 whereby the USB device 114 detects a poor quality USB connection and throttles the connection to improve performance. In this case, the USB device 114 monitors the USB connection. The connection detector circuit 106 starts by clearing 602 all error counters. Errors are then counted 604 and a determination is made whether the error count has exceeded an error count threshold within a set time frame. If the error counter threshold is not exceeded with the set time frame, the algorithm waits 606, clears the error counters 602, and begins another count 604 of errors within the set time frame, i.e. a subsequent instance of the set time frame. If the error counter threshold is exceeded within the set time frame, the algorithm next determines 608 the port speed for the connection: USB3 Gen2 (10G) or USB3 Gen1 (5G). If the error counter threshold is exceeded within the set time frame where the USB connection is configured for USB3.2 Gen2 (10G) speeds, the speed circuit 103 temporarily disconnects 612 the USB3 interface, and reconnects with Gen2 capability bits masked. This action causes the connection to drop to a USB3 Gen 1 (5G) port speed connection. If the error counter threshold is exceeded within the set time frame where the USB connection is configured for USB3.2 Gen 1 (5g) speeds, the speed circuit 103 disconnects/deactivate 614 USB3 interface and issues a USB3 Warm Reset to the port. This action causes the connection to reconfigure for USB2.

For connection quality detection by a USB Device, when an error count rises above a specific threshold within the set time frame, one or more of the routines provided in Table 3 may be initiated.

TABLE 3

| ERROR | | |
|---|---|---|
| CONDITION | REACTION | END RESULT |
| Excessive errors | Temporarily Disconnect/Deactivate | Upstream/Device |
| on Upstream Port | Upstream Port USB3 interface and | Connection will |
| at USB3.2 Gen2 | reconnect with Gen2 capability | drop to USB3 |
| speeds. | bits masked. | Gen 1 |
| Excessive errors | Issue a USB3 Warm Reset to | Connection will |
| on Upstream Port | the Port. | drop to USB2 |
| at USB3.2 Gen1 | Then, Disconnect/Deactivate | |
| speeds. | Upstream Port USB3 interface. | |

This functionality may be implemented in the USB device's 114 firmware or hardware.

Connection detectors 106 or speed circuit 103 as disclosed herein may be implemented in USB3 hubs, USB hosts, and USB devices designed for the automotive industry, in particular, which almost universally adopts USB Type-C ports with USB power delivery.

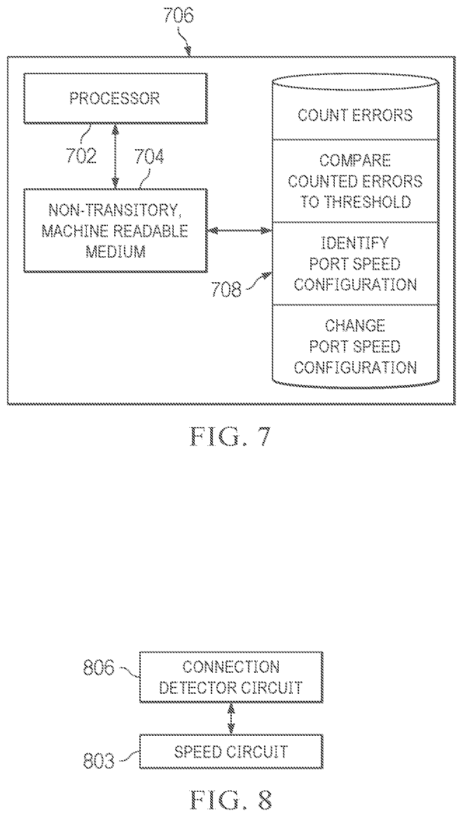

FIG. 7 illustrates a schematic diagram of a connection detector and speed circuit 706 which may be an example of connection detector circuit 106 or speed circuit 103. See FIGS. 1, 3, and 5. This example of the connection detector and speed circuit 706 has a processor 702 and a non-transitory, machine-readable medium 704 including instructions 708. The instructions 708, when loaded and executed by the processor 702, cause the processor 702 to perform automatic USB hub poor link quality detection and speed roll-back. The instructions include: counting errors encountered by a USB connection; comparing a number of counted errors to a preset threshold number of errors; identifying a port speed configuration for the USB connection; and changing the port speed configuration for the USB connection to a slower speed. These functions may also be programed to be performed by the speed circuit 103. See FIGS. 1, 3, and 5.

FIG. 8 shows a schematic diagram for detecting a poor quality USB connection and throttling the connection to improve performance, comprising a connection detection circuit 806 and a speed circuit 803.

Although examples have been described above, other variations and examples may be made from this disclosure without departing from the spirit and scope of these disclosed examples.

What is claimed is:

1. A method comprising:
counting errors encountered by a USB connection;
comparing a number of counted errors to an error count threshold within a set time frame;
identifying a port speed configuration for the USB connection; and
changing the port speed configuration for the USB connection to a slower port speed configuration than the identified port speed configuration.

2. The method as claimed in claim 1, wherein said counting errors comprises counting a type of error selected from: entries to link recovery, warm resets received, retries detected, and link bad commands received.

3. The method as claimed in claim 1, wherein said counting errors comprises counting two or more types of errors selected from: entries to link recovery, warm resets received, retries detected, and link bad commands received.

4. The method as claimed in claim 3, wherein said comparing comprises comparing a respective number of counted errors for the two or more types of errors to a respective error count threshold for the two or more types of errors.

5. The method as claimed in claim 1, wherein identifying a port speed configuration for the USB connection comprises identifying a port speed configuration selected from 10 Gbps) and 5 Gbps.

6. The method as claimed in claim 1, comprising determining whether the USB connection is through an upstream port or a downstream port.

7. The method as claimed in claim 1, wherein changing the port speed for the USB connection to a slower speed comprises changing from 10 Gbps to 5 Gbps.

8. The method as claimed in claim 1, wherein changing the port speed for the USB connection to a slower speed comprises changing from 5 Gbps to 480 Mbps.

9. An apparatus comprising:
a connection detector circuit, wherein the connection detector circuit counts errors encountered by a USB connection, wherein the connection detector circuit compares a number of counted errors to an error count threshold within a set time frame, wherein the connection detector circuit identifies a port speed configuration for the USB connection; and
a speed circuit that changes the port speed configuration of the USB connection to a slower port speed configuration than the identified port speed configuration.

10. The apparatus as claimed in claim 9, wherein said connection detector circuit counts a type of error selected from: entries to link recovery, warm resets received, retries detected, and link bad commands received.

11. The apparatus as claimed in claim 9, wherein said connection detector circuit counts two or more types of errors selected from: entries to link recovery, warm resets received, retries detected, and link bad commands received.

12. The apparatus as claimed in claim 9, wherein said connection detector circuit compares a respective number of counted errors for the two or more types of errors to a respective error count threshold for the two or more types of errors.

13. The apparatus as claimed in claim 9, wherein said connection detector circuit identifies a port speed configuration for the USB connection selected from 10 Gbps and 5 Gbps.

14. The apparatus as claimed in claim 9, wherein connection detector circuit determines whether the USB connection is through an upstream port or a downstream port.

15. The apparatus as claimed in claim 9, wherein the speed circuit reduces the port speed for the USB connection from 10 Gbps to 5 Gbps.

16. The apparatus as claimed in claim 9, wherein the control circuit reduces the port speed for the USB connection from 5 Gbps to 480 Mbps.

17. A system comprising:
a USB hub comprising an upstream port, at least one downstream port, and a switch in electrical communication with the upstream port and the at least one downstream port,
a USB host in electrical communication with the USB hub upstream port via a first USB connection;
a USB device in electrical communication with the at least one USB hub downstream port via a second USB connection;
a connection detector circuit, wherein the connection detector circuit counts errors encountered by either the first or second USB connection, wherein the connection detector circuit compares a number of counted errors to an error count threshold within a set time frame, wherein the connection detector circuit identifies a port speed configuration for either the first or second USB connection; and
a speed circuit that changes the port speed configuration of either the first or second USB connection to a slower port speed configuration than the identified port speed configuration, responsive to the number of counted errors being greater than the error count threshold within the set time frame.

18. The system as claimed in claim 17, wherein the USB hub comprises the connection detector circuit.

19. The system as claimed in claim 17, wherein the USB host comprises the connection detector circuit.

20. The system as claimed in claim 17, wherein the USB device comprises the connection detector circuit.
